(19) United States
(12) Patent Application Publication
(10) Pub. No.: US 2024/0140841 A1
(43) Pub. Date: May 2, 2024

(54) AIR FLOW CONTROL IN A MEMBRANE AERATED BIOFILM REACTOR

(71) Applicant: OXYMEM LIMITED, Athlone (IE)

(72) Inventors: Barry Heffernan, Bushypark (IE); András Németh, Százhalombatta (HU)

(21) Appl. No.: 18/279,604

(22) PCT Filed: Mar. 3, 2022
(86) PCT No.: PCT/EP2022/055405

§ 371 Date: Aug. 31, 2023

(30) Foreign Application Priority Data
Mar. 3, 2021 (GB) 2102980.6

(51) Int. Cl. C02F 3/00; B01D 63/02; C02F 3/10; C02F 3/22; C02F 3/30

(52) U.S. Cl. CPC C02F 3/006; B01D 63/02; C02F 3/102; C02F 3/223; C02F 3/302; C02F 2209/006; C02F 2209/08; C02F 2209/14; C02F 2209/15; C02F 2209/225; C02F 2209/34; C02F 2209/38

(57) ABSTRACT

The present invention provides a method and apparatus for controlling gas flow rate to the membrane of a membrane aerated biofilm reactor (MABR) in order to effect one or more process outcomes, in particular to reduce or minimize N₂O emissions in the exhaust gas from the MABR while managing gas delivery to mixing apparatus of the MABR and maintaining NH₄ and NO₃ targets in the treated effluent, the method comprising monitoring one or more parameters of the wastewater and the exhaust gas and modulating the supply of feed gas to the membrane based on the one or more parameters in order to control the composition of the exhaust gas.

### FIELD OF THE INVENTION

This invention relates to a method and apparatus for controlling gas flow rate to the membrane of a membrane aerated biofilm reactor (MABR) in order to effect one or more process outcomes, in particular to reduce or minimize N₂O emissions in the exhaust gas from the MABR while managing gas delivery to mixing apparatus of the MABR and maintaining NH₄ and NO₃ targets in the treated effluent.

### Background of the Invention

A membrane aerated biofilm reactor (MABR), membrane-aerated biofilm (MAB) and membrane biofilm reactor (MBfR) collectively relate to a process and system where an immobilized community of microorganisms (biofilm) is supported by a permeable membrane as a substratum. The biofilm is in direct contact with one phase, and indirect contact with the other phase via the membrane.

Nutrients for metabolic processes are supplied simultaneously from the two phases. This creates a counter-diffusional biofilm, contrasting the co-diffusional biofilm which develops on non-permeable substrata. The two phases can be liquid-gas or liquid-liquid. In a MABR the gas phase is in contact with the biofilm via the membrane. The gas phase contains air or a gas mixture with a variable concentration of oxygen (up to 100%).

A MABR can be applied to the biological treatment of wastewaters. The biofilm present in an operating MABR accesses pollutants via direct contact with the wastewater, while oxygen is supplied from the gas phase via the membranes to enable aerobic processes to take place. Aerobic processes include the degradation and mineralization of carbonaceous pollutants and oxidation of ammonium to nitrite and nitrate. The bulk liquid in contact with the biofilm may or may not contain additional suspended biomass to complement the biofilm. The reaction-diffusion system of the biofilm creates concentration gradients of the consumed substrates and the products along the axis corresponding to the surface normal to the biofilm and the membrane (assuming idealized, smooth membrane and biofilm surfaces). The concentrations gradients can lead to redox and population stratification of the biofilm. This influences the nature and rate of the biological processes depending on their location between the biofilm-liquid interface and the membrane-biofilm interface. The stratification is influenced by various parameters, such as: biofilm thickness, effective diffusivity of substrates in the biofilm, substrate concentrations in the bulk liquid, oxygen concentration in the gas phase, oxygen transfer characteristics of the membrane, and intrinsic reaction rate of the microorganisms. The conditions leading to biofilm stratification can be influenced by design and operation parameters of the MABR.

The redox stratified biofilm can provide a habitat for autotrophic nitrifying organisms and heterotrophic denitrifying organisms at the same time. Nitrifying organisms grow at the base of the biofilm with good access to oxygen from the membranes and a lack of organic carbon. Heterotrophic denitrifiers occupy the outer biofilm layer with access to carbon substrates from the liquid and a lack of oxygen. Ammonium diffuses through the biofilm to the nitrifier organisms where it becomes oxidized to nitrite and nitrate. Nitrite and nitrate diffuse outward and act as electron acceptors during denitrification in the anoxic biofilm layer.

Nitrous oxide is a by-product of several processes within the biological nitrogen cycle. It has been shown to be produced during both nitrification and denitrification under specific sets of conditions. In the MABR these conditions can present themselves depending on the process parameters and the location within the biofilm. Net nitrous oxide production depends on the balance of nitrous oxide producing and consuming activities in the biomass. Nitrous oxide emission to the environment can happen via the liquid phase in the form of dissolved nitrous oxide or via stripping by the process air. Nitrous oxide is a potent greenhouse gas, and its emission preferably minimized.

One form of MABR is based on a plurality of hollow fibre membranes potted at both ends, forming either a bundle or a mat, allowing gas to flow through. Bundles/mats are potted into headers, forming modules. Modules can be arranged into further larger units. Process air can be distributed to and collected from the modules by a series of manifolds. The membrane assembly is partially or fully submerged in the liquid.

Mixing of the bulk liquid surrounding the MABR is necessary to provide a fresh supply of liquid with nutrients and to minimize mass transfer resistance between the biofilm and the liquid. Mixing can be provided using the exhaust process gas or an individual gas supply. Gas can be utilized for mixing by using it in continuous bubble aeration located under the membranes, intermittent large bubble generator located under the membranes, or an air lift pump.

Applicant's earlier published European patent application EP3582883A1 discloses an exemplary design of enclosure for a membrane aeration module, which incorporates a reversible, low-pressure, air-lift pump to encourage a vertical water flow through and between fibre membranes in the module. These enclosed membrane modules are suitable for use in membrane aerated biofilm reactors (MABRs). EP3582883A1 also includes a comprehensive disclosure of the configuration and operation of the arrays or modules of bundled fibres forming the membrane, in particular the delivery of oxygen to the fibres to diffuse through the membrane to be consumed by the resident biofilm in order to effect oxidation of the biodegradable organic and inorganic wastewater contaminants.

The oxidation of the wastewater contaminants results in the above noted generation of nitrous oxide, which is a problematic by-product of the treatment process, and one which has significant negative environmental impacts.

It is therefore an object of the present invention to provide a method and apparatus for controlling gas flow rate to the membrane of a membrane aerated biofilm reactor (MABR) in order to effect one or more process outcomes, in particular to reduce or minimize N₂O emissions to the environment while maintaining efficient treatment of the wastewater.

### SUMMARY OF THE INVENTION

According to a first aspect of the present invention there is provided a method for controlling the composition of exhaust gas from a membrane aerated biofilm reactor, the method comprising locating the reactor in a reservoir of wastewater; displacing a feed gas along a gas flow path defined at least in part by a membrane at least partially submerged in the wastewater; diffusing at least a component of the gas through the membrane to a biofilm supported on a liquid side of the membrane; extracting an exhaust gas from the gas flow path downstream of the membrane; monitoring one or more parameters of the wastewater and/or the exhaust gas and/or the feed gas; and modulating the supply of feed gas to the membrane based on the one or more parameters in order to control the composition of the exhaust gas.

Preferably, the method comprises modulating the supply of feed gas to the biofilm in order to control the level of nitrous oxide in the exhaust gas.

Preferably, the method comprises modulating the supply of feed gas to the biofilm in order to control the composition of contaminants in the wastewater.

Preferably, the method comprises modulating the supply of feed gas to the biofilm in order to control the levels of ammonium and/or nitrate in the wastewater.

Preferably, the one or more parameter is dissolved oxygen and/or oxidation reduction potential and/or pH and/or temperature and/or chemical oxygen demand and/or total organic carbon and/or ammonia concentration and/or nitrogen dioxide concentration and/or nitrate concentration and/or total nitrogen concentration of the wastewater, biofilm thickness, and oxygen transfer rate and/or oxygen transfer efficiency and/or oxygen concentration and/or nitrous oxide concentration in the exhaust gas.

Preferably, the method comprises the step of mixing the wastewater to provide a continuous supply of nutrients to the biofilm on the membrane.

Preferably, the method comprises modulating the mixing based on the one or more monitored parameters in order to control the composition of the exhaust gas.

Preferably, the method comprises feeding the exhaust gas to a nitrous oxide scrubber.

Preferably, the mixing is achieved through air lift mixing.

Preferably, the method comprises utilising a single gas supply for the feed gas and the air lift mixing.

Preferably, the method comprises recycling the exhaust gas into the feed gas.

Preferably, the method comprises utilising an algorithm to process the one or more parameters in order to modulate the supply of feed gas to the membrane.

Preferably, the algorithm is adapted to effect feedback and feedforward control of the modulation of the supply of feed gas to the membrane.

Preferably, the algorithm utilises one or more set points of the monitored parameters in controlling the modulation of the supply of feed gas to the membrane.

Preferably, the method comprises modulating the supply of the feed gas to the membrane with a gas flow valve controlled by the algorithm.

According to a further aspect of the present invention there is provided a method for controlling the level of nitrous oxide in exhaust gas from a membrane aerated biofilm reactor while ensuring the simultaneous occurrence of nitrification and denitrification within the biofilm, the method comprising locating the reactor in a reservoir of wastewater; displacing air or oxygen as a feed gas along a gas flow path defined at least in part by a membrane at least partially submerged in the wastewater; diffusing oxygen from the feed gas through the membrane to a biofilm supported on a liquid side of the membrane; extracting an exhaust gas from the gas flow path downstream of the membrane; monitoring the mass of chemical oxygen demand and the level of ammonia in the wastewater; and modulating the supply of oxygen to the membrane based on the mass of chemical oxygen demand and the level of ammonia in the wastewater in order to control the level of nitrous oxide in the exhaust gas.

According to a still further aspect of the present invention there is provided a membrane aerated biofilm reactor for processing wastewater, the reactor comprising one or more membranes defining a flow path along which a feed gas may be supplied to the membrane for diffusion therethrough and from which an exhaust gas can be extracted downstream of the membrane; one or more sensors operable to monitor one or more parameters of the wastewater and/or exhaust gas and/or feed gas;

and a controller arranged to receive the monitored parameters and modulate the supply of feed gas to the membrane in order to control the composition of the exhaust gas.

Preferably, the controller is operable to modulate the supply of feed gas to the biofilm in order to control the level of nitrous oxide in the exhaust gas.

Preferably, the controller is operable to modulate the supply of feed gas to the biofilm in order to control the composition of contaminants in the wastewater.

Preferably, the controller is operable to modulate the supply of feed gas to the biofilm in order to control the levels of ammonium and/or nitrate in the wastewater.

Preferably, the one or more sensors are operable to monitor dissolved oxygen and/or oxidation reduction potential and/or pH and/or temperature and/or chemical oxygen demand and/or total organic carbon and/or ammonia concentration and/or nitrogen dioxide concentration and/or nitrate concentration and/or total nitrogen concentration of the wastewater, biofilm thickness, and oxygen transfer rate and/or oxygen transfer efficiency and/or oxygen concentration and/or nitrous oxide concentration in the exhaust gas.

Preferably, the reactor comprises an array of hollow fibres the outer surface of which collectively define the membrane.

Preferably, each hollow fibre comprises an internal lumen which collectively define the flow path along which the feed gas may be supplied to the membrane for diffusion therethrough.

Preferably, the reactor comprises a gas flow control valve on the flow path and operable by the controller to modulate the supply of feed gas to the membrane.

Preferably, the controller is programmed with an algorithm to process the one or more parameters in order to modulate the supply of feed gas to the membrane.

Preferably, the reactor comprises a nitrous oxide scrubber to which the exhaust gas is fed.

Preferably, the reactor comprises an air lift mixer.

Preferably, the reactor comprises a single gas supply for the feed gas and the air lift mixer.

As used herein, the term “membrane” is intended to mean a substratum on which a biofilm may be supported for the biological processing of wastewater, the membrane defining a gas side and a liquid side on opposed faces, whereby a feed gas is diffusible from the gas side to the liquid side, the membrane preferably being defined by the combined surfaces of a large array of hollow fibres having a lumen defining a flow path into which feed gas is supplied and from which exhaust gas is extracted, the feed gas being partially diffusible from the interior gas side to the exterior liquid side of the surface of the hollow fibres.

As used herein, the term “wastewater” is intended to mean any supply of water containing contaminants to be removed or reduced in concentration, and may include wastewater in combination with activated sludge.

As used herein, the term “exhaust gas” is intended to mean the gas that is extracted from a membrane or array of membranes after oxygen or other gases from a feed gas have diffused through the membrane from the gas side to the liquid side in order to supply a biofilm supported on the membrane, and which exhaust gas may comprises constituents which have diffused from liquid side to the gas side.

As used herein, the term “contaminants” is intended to mean organics (e.g. COD, BOD, TOC, etc.) and/or nutrients (e.g. NH₄, NO₃, NO₂, P, etc.) dissolved or otherwise contained in fluid such as wastewater or the like.

### BRIEF DESCRIPTION OF THE DRAWINGS

The present invention will now be described with reference to the accompanying drawings, in which:

FIG. 1 illustrates a schematic representation of a membrane aerated biofilm reactor according to an embodiment of the present invention;

FIG. 2 is a graph showing the correlation between air supply rate and nitrous oxide emission as established through bench scale experiments; and

FIG. 3 is a graph showing how the maximum nitrification efficiency becomes limited when the exhaust gas oxygen concentration falls below a particular percentage.

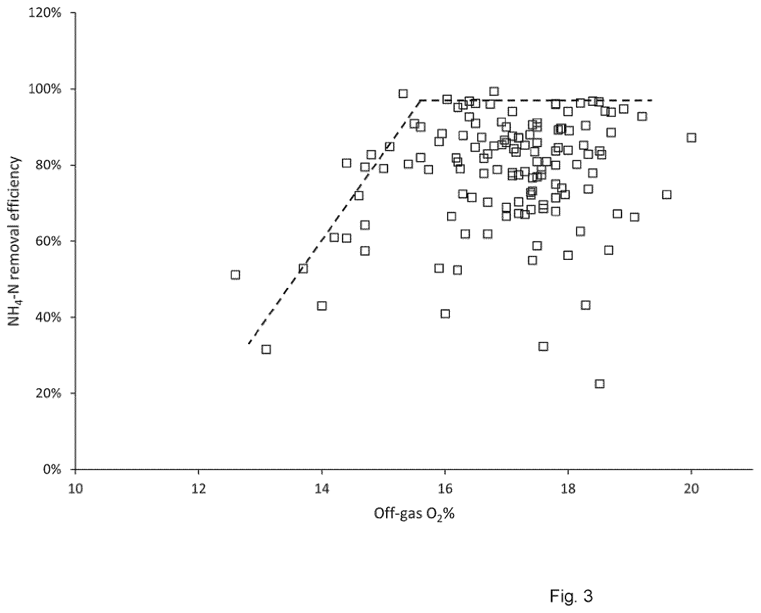

### DETAILED DESCRIPTION OF THE DRAWINGS

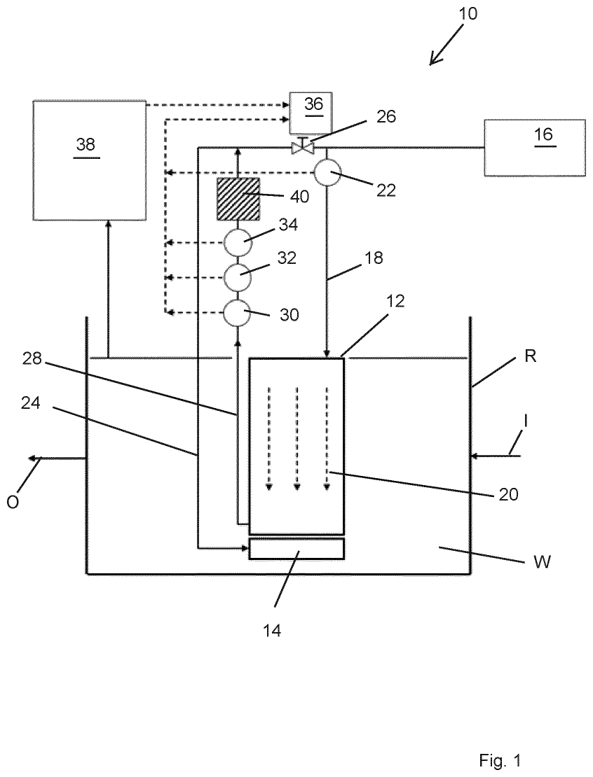

Referring now to FIG. 1 of the accompanying drawings there is illustrated a schematic representation of a membrane aerated biofilm reactor (MABR), generally indicated as 10, for use in effecting the biological processing of wastewater or the like, for example in a municipal wastewater treatment facility (not shown) or the like.

In the exemplary embodiment illustrated the reactor 10 is in the form of a module which may be located or retrofitted into a reservoir R containing wastewater W to be treated, but it should be understood by a person of ordinary skill that the reactor 10 may be integrated or designed into a wastewater treatment facility from inception. It should also be understood that the modular form allows more than one of the reactors 10 to be utilized within a single reservoir or treatment facility, whether in parallel or in series. The reservoir R includes an inlet I by which untreated wastewater W may be introduced into the reservoir R and an outlet O via which treated wastewater W may be withdrawn. The reservoir R defines a large volume within which a bulk volume of the wastewater W can be retained for the necessary processing periods (hydraulic retention time), which can be monitored and optimized, whether manually or automatically, to provide required processing outcomes.

The reactor 10 optionally comprises a housing or enclosure 12 within which is located an array of membrane cassettes (not shown), each of which includes a large number of preferably linearly and more preferably vertically extending hollow fibres (not shown) arranged in bundles and captured between an upper and a lower gas manifold (not shown) with which an inner lumen of each fibre is in communication. In this way a gas, for example air or oxygen, can be pumped or otherwise displaced through the lumen from one end of each fibre to the other, for example from the top to the bottom. A sidewall of the hollow fibre defines the membrane though which gas, for example oxygen, can diffuse from an air side of the membrane, namely the inner surface defining the lumen, to a liquid side of the membrane, namely the outer surface of the fibre which in use is at least partially and preferably fully submerged in the wastewater W. In use a biofilm colonizes the outer surface of the fibres. The biofilm accesses pollutants via direct contact with the wastewater W, while gas such as oxygen is supplied from the gas phase via the lumen in each of the fibres (not shown) to enable aerobic processes to take place in order to effect the biological process of the wastewater in known fashion. Aerobic processes include the degradation and mineralization of carbonaceous pollutants and oxidation of ammonium to nitrite and nitrate.

In order to ensure an adequate supply of nutrients to the biofilm from the wastewater W the reactor 10 comprises or is in operative association with a mixer 14 represented schematically in FIG. 1, and which is operable to effect the circulation of fluid over the biofilm to provide the necessary supply of nutrients. The mixer 14 is shown beneath the enclosure 12 to represent a convention bubble mixer, although it will be appreciated that an airlift type mixer may also be employed, or any other suitable functional equivalent. A detailed description of the configuration and operation of such a reactor is provided in the Applicant's earlier published European patent application EP3582883A1, and it is to be understood that the reactor 10 of the present invention is of essentially the same configuration in relation to the possible arrangement of the fibres, the supply of gas through the lumen of the fibres to diffuse outwardly for use by the biofilm, and optionally the arrangement of the airlift mixer in place of the schematically represented bubble mixer 14.

The reactor 10 comprises or is connectable with a gas supply 16, for example a pump for displacing air, from which extends a feed line 18 arranged to supply air (or other feed gas) to the membrane, most preferably in the manner described in detail in EP3582883A1. As noted above the membrane is defined collectively by the arrays of fibres contained within the enclosure 12, which fibres (and the downward flow of air through their lumens) is represented schematically by the arrows 20 in FIG. 1. A gas flow meter 22 is provided on the feed line 18 to facilitate the real time monitoring of the volume of air being supplied to the membrane. A mixer supply line 24 also extends from the gas supply 16 to feed air to the mixer 14. While the exemplary embodiment illustrated utilises the gas supply 16 as a common source of air for supplying both the membrane and the mixer 14 it will of course be understood that a separate gas supply for each may be employed. An air flow control valve 26 is provided between the feed line 18 and the mixer supply line 24 and is operable, as described in detail hereinafter, to automatically modulate the volume of air supplied to the membrane and/or the mixer 14 to achieve desired process outcomes, most notably controlling the nitrous oxide in the exhaust gas from the membrane and the maintenance of target levels of NH₄ and NO₃ in the treated wastewater W. An additional or alternative process outcome is to ensure the simultaneous occurrence of nitrification and denitrification within the biofilm.

The position of the control valve 26 could be varied, for example to be located solely on the feed line 18 so as to control only the air supplied to the membrane. Alternatively a pair of control valves (not shown) could be employed, one located on each of the feed line 18 and the mixer supply line 24, to facility the independent control of air flow to the fibres 20 and mixer 12.

Returning from the lower end of the fibres is an exhaust line 28 which withdraws exhaust gas from the membrane and in the exemplary embodiment illustrated recirculates or recycles the exhaust gas into the mixer supply line 24 downstream of the control valve 26. It should however be understood that the exhaust line 28 could simply be open to atmosphere, or could be passed to an external device for the capture and removal of nitrous oxide, for example an optional nitrous oxide scrubber 40. However by recirculating the exhaust gas into the mixer supply line 24 downstream of the control valve 26, or in other words downstream of the air/oxygen feed line 18 to the membrane, provides the combined benefits of maintaining the necessary air flow rate to manage mixing while also affecting process outcomes such as effluent quality and N₂O emissions.

As is known in the art, the feed gas, in particular air/oxygen, diffuses through the membrane to be utilised by the biofilm in processing the wastewater. The biological processes produce nitrous oxide as one by-product, which diffuses back through the membrane to the gas side lumen to then be extracted via the exhaust line 28. Located on the exhaust line 28 are a nitrous oxide sensor 30, a gas flow meter 32 and an oxygen sensor 34. The relative positions of these sensors may be varied. Each of these sensors, along with the gas flow meter 22 on the feed line 18, are arranged in data communication with a controller 36 which is programmed with an algorithm which utilises data from one or more of the sensors to control the flow of air to the membrane via the control valve 26 in order to minimise nitrous oxide in the exhaust gas extracted from the membrane through the exhaust line 28 while also ensuring sufficient supply of oxygen to the biofilm to avoid inhibition of nitrification and thus maintain certain target concentrations in the treated wastewater W, in particular NH₄ and NO₃ targets.

In order to monitor the wastewater W the reactor 10 further comprises a water quality sensor or suite of sensors 38 arranged to monitor one or more parameters of the wastewater W, which may be the influent wastewater, effluent wastewater, or the bulk liquid wastewater in which the enclosure 12 is submerged. The parameters to be monitored may be one or more of dissolved oxygen, oxidation reduction potential, pH, temperature, chemical oxygen demand, organic carbon, ammonia concentration, nitrogen dioxide concentration, nitrate concentration, and total nitrogen concentration, of the wastewater, and further gas side parameters such as the oxygen transfer rate and/or oxygen transfer efficiency of the exhaust gas. It will also be understood that any other suitable parameter may be monitored and used to provided feedback and/or feedforward control via the algorithm running on the controller 36. The control algorithm considers real time values of the above water quality parameters along with exhaust gas concentrations (e.g. O₂; N₂O as monitored by the nitrous oxide sensor 30 and oxygen sensor 34) combined with set points of water quality and/or exhaust gas concentrations (such as NH₄ and NO₃ targets) in order to determine membrane air flow requirements, and the controller 36 sends the necessary signals to adjust the air flow to the membrane and/or mixer 14 to achieve and/or maintain the desired process outcomes. In an exemplary embodiment air flow is modulated to a flow rate of 2.5-13.8 L/m²h and volume specific air flow rate of 1.0-4.5 m³/m³ h in order to deliver minimum air flow to the mixer 14 to provide sufficient mixing and minimum air flow to the membrane to provide sufficient oxygen to meet effluent NH₄ and NO₃ targets.

In the counter-diffusional biofilm of the reactor 10 nitrification and denitrification can take place simultaneously, depending on the local concentrations of dissolved oxygen, ammonium, nitrite and the population stratification and density of the biofilm on the membrane. Nitrous oxide can be produced via the currently known pathways of nitrifier denitrification, incomplete hydroxylamine oxidation, abiotic nitrous oxide formation and reduction of nitric oxide (NO) by heterotrophic denitrification. Heterotrophic denitrification is also a sink for nitrous oxide, reducing it further to molecular nitrogen. Each production pathway can potentially be influenced by changing the concentration gradients in the biofilm. Concentration gradients are subject to change by changing biological activity, changing bulk liquid concentrations and changing partial pressures in the membrane lumen.

Partial pressure of gases in the membrane lumen of each fibre depends on the gas flow rate. e.g., higher flow rates result in higher outlet oxygen concentration (a gas which is transferred from the gas phase to the liquid phase) or lower CO₂ and N₂O concentrations (gases which are transferred from the liquid phase to the gas phase).

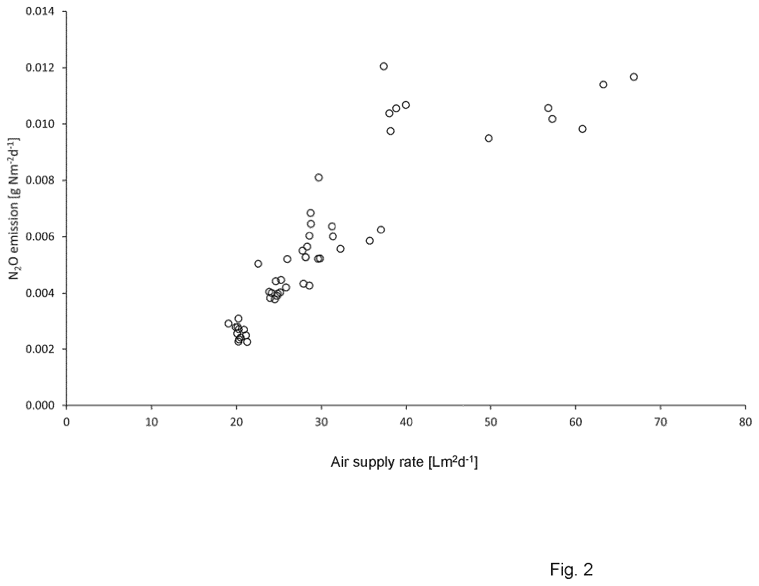

The invention resides in the recognition of a particular relationship or correlation between one or more process parameters of the reactor 10 and the generation of nitrous oxide as a by-product of the biological processing of the wastewater W by the biofilm, which correlation can be utilised within the algorithm to operate the control valve 26 to achieve the desired process outcomes. In particular the reactor 10 operates on the basis of the correlation between the air/oxygen flow rate to the membrane and nitrous oxide emission from the biofilm, which nitrous oxide diffuses back through the membrane to the gas side to form a constituent component of the exhaust gas extracted through the exhaust line 28 and which can therefore be monitored by the controller 26 via the nitrous oxide sensor 30. The positive correlation between gas flow rate and nitrous oxide emission, based on theoretical considerations regarding biological processes concerning nitrous oxide production and the diffusion-reaction system of the counter-diffusional biofilm, has been established experimentally and illustrated in FIG. 2.

As established, varying the air/oxygen flow rate to the membrane affects the production of nitrous oxide in the biofilm. The following relationships are also potential process parameters which can be used as inputs to the controller 26 which can be utilised by the algorithm to effect control of the air/oxygen supply to the membrane:
Air flow rate affects oxygen partial pressure
Oxygen partial pressure influences dissolved oxygen concentration profile in the biofilm
Dissolved oxygen concentration profile influences the rates of the various metabolic pathways involved in production and consumption of nitrous oxide in the biofilm
Air flow rate affects nitrous oxide partial pressure in the gas phase
N₂O partial pressure influences transfer of N₂O across the membrane to the gas side
N₂O transfer across the membrane to the gas side affects concentration gradient and mass transfer of N₂O in the biofilm
Potentially less N₂O diffuses to the outer anoxic layer of the biofilm where it could be consumed in denitrification

As a consequence of the above, higher air flow rates to the membrane, as generated and/or controlled by the gas supply 16 and the control valve 26, result in higher nitrous oxide emissions from the biofilm and thus in the exhaust gas. As a result it has been established that mitigating the emission of nitrous oxide is possible by reducing the air flow rate to the membrane. However, supplying the necessary amount of oxygen to the membrane is required to enable the aerobic processes (e.g. nitrification) to take place in the biofilm at the desired rate. Therefore, the aim of controlling the air flow rate to the membrane/biofilm is to provide the necessary amount of oxygen to the biofilm while avoiding oversupply in order to minimize N₂O emission.

As the reactor 10 is energy efficient there is not a significant requirement to optimize aeration from an energy perspective. However reducing aeration may not facilitate simultaneous nitrification and denitrification when the load to the reactor 10 is low, due to an oversupply of oxygen. The reactor 10 solves this problem by measuring process parameters, for example the mass of COD and ammonia in the influent, and controlling the amount of air or oxygen that is supplied to the membrane with the remaining sent to the bubble mixer 14 or any alternative airlift mixer that may be utilised in place of the schematically represented bubble mixer 14. By recirculating the exhaust gas from the membrane to the mixer 14 it is possible to manage the mixing air flow and membrane air flow simultaneously. This allows the flow rate to the mixer 14 to be maintained at the correct level while controlling the flow rate to the membrane.

However it will also be understood that alternative process parameters or combinations thereof may be monitored for the above purpose, for example monitoring N₂O, NO₃ along with COD. While ensuring there is sufficient soluble biodegradable COD it is also necessary to avoid an oversupply of air or oxygen to the reactor 10 otherwise the bacteria in the biofilm will use oxygen and not nitrate as the terminal electron acceptor.

Ensuring the supply of the necessary amount of oxygen can be realized by various means, a non exhaustive list of examples being:
The air flow rate can be calculated from the theoretical oxygen demand and the oxygen transfer efficiency of the bulk wastewater W.
The theoretical oxygen demand can be calculated from the influent load (e.g. based on inlet water flow rate and inlet ammonium or TN concentration).
Theoretical oxygen demand can be calculated from the substrate concentration in the reactor 10 and the relating biological activity based on the reaction kinetics of the reactor 10 (e.g. relationship between ammonium concentration and ammonium oxidation rate).
The targeted oxygen transfer efficiency can be used to achieve the necessary oxygen transfer rate.
The air flow rate can be regulated based on a target exhaust gas oxygen concentration
The concentration of oxygen in the exhaust gas is indicative of the average oxygen partial pressure in the membrane fibre lumens
As long as sufficient oxygen partial pressure is maintained in the fibre lumens, the necessary driving force to facilitate oxygen transfer is ensured.
With the above driving force present, the aerobic processes can be considered unhindered (similar to dissolved oxygen concentration based aeration control for conventional aeration) (Error! Reference source not found).

The control algorithm may utilize one or more control structures in order to analyze and determine in which direction the algorithm program flows, using data from one or more of the process parameters detailed above, and for example:
The controlled parameter is the air flow rate to the membrane. Setpoint can be determined based on inlet load (COD, TN, NH₄—N) or effluent/bulk liquid concentration of water quality parameters (COD, TOC, NH₄—N, NO₂—N, NO₃—N). Feed forward control can be realized based on inlet load, feedback control based on effluent/bulk liquid concentrations. Feed forward and feedback controls can be combined.
Controlled parameter is the dissolved oxygen (DO) concentration
Controlled parameter is the oxidation reduction potential (ORP)
Controlled parameter is the effluent water quality (COD, TOC, NH₄—N, NO₂—N, NO₃—N, TN)
Controlled parameter is based on gas-side oxygen mass balance (off-gas O₂%, OTR, OTE)
A combination of the above is possible (e.g. feed forward control based on inlet NH₄—N load and feedback control based on effluent NH₄—N and off-gas 02%)

By controlling the reactor 10 in the above manner there are a number of potential outcomes and/or benefits, namely:
Energy savings—in particular if the membrane air supply is provided or modulated independently of the mixing air or the mixing air flow is not constant.
Nitrification—supplying sufficient oxygen for ammonium oxidation
Nitritation—supplying sufficient oxygen for ammonium oxidation but suppressing nitrite oxidation
Denitrification—Preventing excess oxygen transfer to allow the development of anoxic zones in the biofilm where denitrification can take place
N₂O emission—mitigating N₂O emissions by minimizing the stripping via the process gas and allowing more N₂O to be consumed by denitrification

It will therefore be understood that the reactor 10, and in particular the method of controlling the reactor 10 by modulating the air flow to the membrane and/or the mixer 14, allows for a significant reduction and preferably a minimizing of the production of harmful nitrous oxide, while simultaneously achieved desired processing targets, most notably NH₄ and NO₃ targets in the treated wastewater.

1. A method for controlling the composition of exhaust gas from a membrane aerated biofilm reactor, the method comprising locating the reactor in a reservoir of wastewater; displacing a feed gas along a gas flow path defined at least in part by a membrane at least partially submerged in the wastewater; diffusing at least a component of the gas through the membrane to a biofilm supported on a liquid side of the membrane; extracting an exhaust gas from the gas flow path downstream of the membrane; monitoring one or more parameters of the wastewater and/or the exhaust gas and/or the feed gas; and modulating the supply of feed gas to the membrane based on the one or more parameters in order to control the composition of the exhaust gas.

2. A method according to claim 1 comprising modulating the supply of feed gas to the biofilm in order to control the level of nitrous oxide in the exhaust gas.

3. A method according to claim 1 or 2 comprising modulating the supply of feed gas to the biofilm in order to control the composition of contaminants in the wastewater.

4. A method according to claim 3 comprising modulating the supply of feed gas to the biofilm in order to control the levels of ammonium and/or nitrate in the wastewater.

5. A method according to any preceding claim in which the one or more parameter is dissolved oxygen and/or oxidation reduction potential and/or pH and/or temperature and/or chemical oxygen demand and/or total organic carbon and/or ammonia concentration and/or nitrogen dioxide concentration and/or nitrate concentration and/or total nitrogen concentration of the wastewater, biofilm thickness, and oxygen transfer rate and/or oxygen transfer efficiency and/or oxygen concentration and/or nitrous oxide concentration in the exhaust gas.

6. A method according to any preceding claim comprising the step of mixing the wastewater to provide a continuous supply of nutrients to the biofilm on the membrane.

7. A method according to claim 6 comprising modulating the mixing based on the one or more monitored parameters in order to control the composition of the exhaust gas.

8. A method according to any preceding claim comprising the step of feeding the exhaust gas to a nitrous oxide scrubber.

9. A method according to any of claims 6 to 8 in which the mixing is achieved through air lift mixing.

10. A method according to claim 9 comprising utilising a single gas supply for the feed gas and the air lift mixing.

11. A method according to any preceding claim comprising recycling the exhaust gas into the feed gas.

12. A method according to any preceding claim comprising utilising an algorithm to process the one or more parameters in order to modulate the supply of feed gas to the membrane.

13. A method according to claim 12 in which the algorithm is adapted to effect feedback and feedforward control of the modulation of the supply of feed gas to the membrane.

14. A method according to claim 12 or 13 in which the algorithm utilises one or more set points of the monitored parameters in controlling the modulation of the supply of feed gas to the membrane.

15. A method according to any of claims 12 to 14 comprising modulating the supply of the feed gas to the membrane with a gas flow valve controlled by the algorithm.

16. A method according to any preceding claim comprising displacing air or oxygen as the feed gas along the gas flow path; diffusing oxygen from the feed gas through the membrane to the biofilm; monitoring the mass of chemical oxygen demand and the level of ammonia in the wastewater; and modulating the supply of oxygen to the membrane based on the mass of chemical oxygen demand and the level of ammonia of the wastewater in order to control the level of nitrous oxide in the exhaust gas and ensure the simultaneous occurrence of nitrification and denitrification within the biofilm.

17. A membrane aerated biofilm reactor for processing wastewater, the reactor comprising one or more membranes defining a flow path along which a feed gas may be supplied to the membrane for diffusion therethrough and from which an exhaust gas can be extracted downstream of the membrane; one or more sensors operable to monitor one or more parameters of the wastewater and/or exhaust gas and/or feed gas; and a controller arranged to receive the monitored parameters and modulate the supply of feed gas to the membrane in order to control the composition of the exhaust gas.

18. A reactor according to claim 16 in which the controller is operable to modulate the supply of feed gas to the biofilm in order to control the level of nitrous oxide in the exhaust gas.

19. A reactor according to claim 16 or 17 in which the controller is operable to modulate the supply of feed gas to the biofilm in order to control the composition of contaminants in the wastewater.

20. A reactor according to claim 18 in which the controller is operable to modulate the supply of feed gas to the biofilm in order to control the levels of ammonium and/or nitrate in the wastewater.

21. A reactor according to any of claims 16 to 19 in which the one or more sensors are operable to monitor dissolved oxygen and/or oxidation reduction potential and/or pH and/or temperature and/or chemical oxygen demand and/or total organic carbon and/or ammonia concentration and/or nitrogen dioxide concentration and/or nitrate concentration and/or total nitrogen concentration of the wastewater, biofilm thickness, and oxygen transfer rate and/or oxygen transfer efficiency and/or oxygen concentration and/or nitrous oxide concentration in the exhaust gas.

22. A reactor according to any of claims 16 to 20 comprising an array of hollow fibres the outer surface of which collectively define the membrane.

23. A reactor according to claim 21 in which each hollow fibre comprises an internal lumen which collectively define the flow path along which the feed gas may be supplied to the membrane for diffusion therethrough.

24. A reactor according to any of claims 16 to 22 comprising a gas flow control valve on the flow path and operable by the controller to modulate the supply of feed gas to the membrane.

25. A reactor according to any of claims 16 to 23 in which the controller is programmed with an algorithm to process the one or more parameters in order to modulate the supply of feed gas to the membrane.

26. A reactor according to any of claims 16 to 24 comprising a nitrous oxide scrubber to which the exhaust gas is fed.

27. A reactor according to any of claims 16 to 25 comprising an air lift mixer.

28. A reactor according to claim 26 comprising a single gas supply for the feed gas and the air lift mixer.
